(19) United States
(12) Patent Application Publication
(10) Pub. No.: US 2015/0155766 A1
(43) Pub. Date: Jun. 4, 2015

(54) High Slip Variable Frequency Induction Motors

(71) Applicant: Eaton Limited, Titchfield Hampshire (GB)

(72) Inventor: Brian Alan Cooper, Locksheath (GB)

(21) Appl. No.: 14/552,582

(22) Filed: Nov. 25, 2014

(30) Foreign Application Priority Data
Dec. 4, 2013 (GB) 1321420.0

(51) Int. Cl. H02K 17/16; F04B 17/03; H02K 11/00

(52) U.S. Cl. CPC H02K 17/165; H02K 11/0073; F04B 17/03

(57) ABSTRACT

A high slip variable frequency induction motor has a rotor including an elongate stacked lamination core having a length and diameter, a plurality of electrically conducting rotor bars extending through said core, each having a first end and a second end, and electrically conducting first and second end rings electrically connected to the first and second ends respectively of said rotor bars. An insulating material is disposed between said rotor bars and said core thereby to at least prevent parasitic current flow between the rotor bars and said core.

### CROSS-REFERENCE TO RELATED APPLICATIONS

Priority is claimed to British Patent Application No. 1321420.0, filed on Dec. 4, 2013, the entire disclosure of which is hereby incorporated by reference herein.

### FIELD

This invention relates to high slip variable frequency induction motors and in particular, but not exclusively to rotors for use in such motors, to methods for production thereof, and to fuel pump arrangements utilizing such motors.

### BACKGROUND

In a typical design of an induction motor, a squirrel cage rotor is rotatably mounted within a stator containing electrical windings. The rotor is formed of an elongate core of stacked laminations of magnetic material arranged concentrically with the rotor shaft, and a squirrel cage construction made up of rotor bars extending through the core and being connected at opposite ends by respective conducting end rings. In use, a current is induced in the rotor by applying voltage to the stator windings and the induced current flows around a circuit defined by successive adjacent pairs of rotor bars and closed by the respective end rings. In conventional induction motors, the core is not electrically insulated from the rotor bars. This does not significantly affect performance because, for typical operating regimes, the bar axial impedance of the bar in the axial direction is substantially lower than the impedance measured circumferentially between two adjacent bars and the core material (the inter-bar impedance).

### SUMMARY

We have however found that in certain operating regimes, and in particular in high slip variable frequency induction motors where the rotor is subject to drag (for example if it is immersed in a coolant fluid), it is preferred to design the rotor to be of relatively small diameter and relatively long length to reduce the drag. Also to mitigate the speed variation due to the variable frequency the rotor is designed to be high slip, which means by design the rotor bars are higher resistance (5 to 10 times higher resistance) than a typical rotor design. This is typically achieved by using a high resistivity material such as brass, phosphor bronze, or aluminum alloy. Typical materials may have a resistivity of greater than 5×10⁻⁸ Ωm. This geometry and material selection means that the ratio of bar axial impedance to inter-bar impedance becomes significantly greater and indeed in variable frequency motors can approach unity. Based on our analysis we have designed rotors and methods for production thereof which provide insulation between the rotor bars and the core material, thereby to reduce parasitic inter-bar current flow and thereby improving the efficiency of the rotors.

An aspect of the invention provides a rotor for a high slip variable frequency induction motor, the rotor comprising: an elongated stacked lamination core having a length and diameter; a plurality of electrically conducting rotor bars extending through the elongated stacked lamination core, each of the rotor bars having a first end and a second end; an electrically conducting first end rings; and an electrically conducting second end ring. The electrically conducting first and second end rings are connected to the first and second ends respectively of the rotor bars. An insulating material is disposed between the rotor bars and the elongated stacked lamination core so as to reduce or prevent parasitic current flow between the rotor bars and the elongated stacked lamination core.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic diagram of an embodiment of a fuel pump arrangement utilizing an induction motor in accordance with this invention, and

FIG. 2 is a schematic view of the rotor for the motor of FIG. 1.

### DETAILED DESCRIPTION

One aspect of this invention provides a rotor for a high slip variable frequency induction motor, said rotor including:
an elongate stacked lamination core having a length and a diameter,
a plurality of electrically conducting rotor bars extending through said core, each having a first end and a second end, and
electrically conducting first and second end rings electrically connected to the first and second ends respectively of said rotor bars,
wherein an insulating material is disposed between said rotor bars and said core thereby to at least reduce parasitic current flow between the rotor bars and said core.

Preferably the insulating material is sufficient to bring the parasitic loss down to less than 1-5%, depending upon the design.

The parasitic loss may be defined in terms of a reduction in electromagnetic torque produced for a given speed, typically of the order of 10-20% of the theoretical ideal in conventional designs.

In high slip variable frequency motors according to the invention, the ratio of the axial impedance to the impedance measured between the bars is advantageously at least 5:1 and preferably 50:1 or more.

The rotor bars may be insulated from the core material by providing insulating material associated with the bars and/or said core material. Thus for example a surface treatment may be applied to said rotor bars. The treatment may comprise coating with a ceramic or ceramic based insulating coating, by a suitable process such as plasma coating a water-based ceramic material onto the surface. Where said rotor bars are formed of aluminum, or an alloy thereof, for example by extrusion, said treatment may comprise anodizing said bars to provide an insulating anodic coating.

Additionally or alternatively a suitable surface treatment may comprise surface treatment to the surfaces of said core adjacent said rotor bars.

Preferably said coating has a breakdown voltage of less than 10 Volts.

The invention extends to an electric motor arrangement including a rotor as described above connected to a variable frequency constant voltage source as typically found on latest generation aircraft; the connection is preferably a direct connection. A significant advantage is the ability of the motor to operate directly from the aircraft variable frequency supply (360-800 Hz).

Preferably said motor has a power output in a range of from 0.5 to 10 kW.

The invention also extends to a method of reducing parasitic current flow in a variable frequency induction motor having a rotor including an elongate stacked laminated core, a plurality of electrically conducting rotor bars extending through said core and each having a first and a second end with the first and second ends being electrically connected by respective first and second end rings, the method comprising providing an insulating material between the rotor bar and the core thereby to prevent or reduce current flow between the bars and the core.

The invention also extends to method of forming a rotor for a variable frequency induction motor, which comprises:
providing an elongate stacked lamination core with a plurality of electrically conducting rotor bars extending through said core each having a first and a second end, with the first and second ends being electrically connected by respective first and second end rings, and
providing an insulating material between the rotor bar and the core, thereby to prevent or reduce current flow between the rotor bars and the said core in operation.

The invention also extends to a fuel pump arrangement comprising a pump and an electric motor designed to be located in a fuel tank and immersed in fuel in use, said electric motor comprising a rotor as set out above. Preferably said rotor is immersed in sad fuel in use to effect cooling thereof

Whilst the invention has been described above, it extends to any inventive combination or sub-combination of the features set out above, or in the following description, drawings or claims.

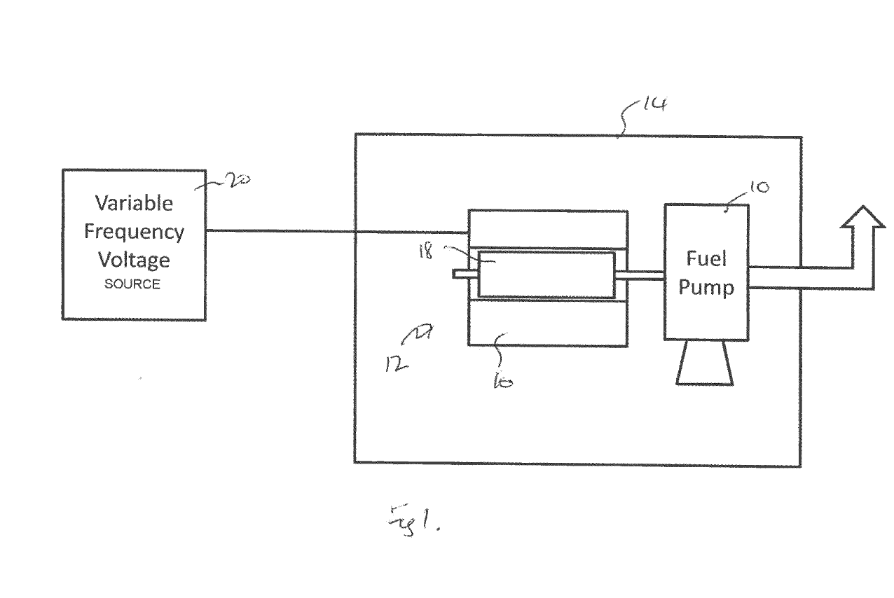

Referring initially to FIG. 1, there is shown an aircraft fuel pump system for use on board an aircraft. A fuel pump 10 and an electric motor 12 that drives the pump 10 are located within a fuel tank 14 so that the fuel acts as a coolant for the electric motor. The electric motor 12 is a variable frequency electrical induction motor, including a stator 16 having windings, and a rotor 18 of squirrel cage construction to be described in more detail below. A variable frequency voltage source 20 situated outside the fuel tank provides a variable frequency drive to the electric motor. The rotor 18 is immersed in fuel which is present in the cylindrical gap between the stator 16 and the rotor 18 to provide a beneficial cooling effect, but this also provides drag. In order to reduce the amount of drag, the ratio of the length to the diameter of the rotor is greater than is normally the case in such motors, so that the rotor is of reduced diameter for a given power output. In this embodiment, the ratio of the length to the diameter is 3:1. Also as noted above the bars are of higher than usual resistivity. For low slip motors typical materials for the bars include copper with a resistivity of 1.7 micro-ohm·cm, and aluminum with a resistivity of 3.4 micro-ohm·cm. For high slip motors typical materials for the bars include phosphor bronze 510 with a resistivity of 11.54 micro-ohm·cm, brass (37% Zn) with a resistivity of 6.54 micro-ohm·cm, and aluminum alloy 380 with a resistivity of 6.54 micro-ohm·cm.

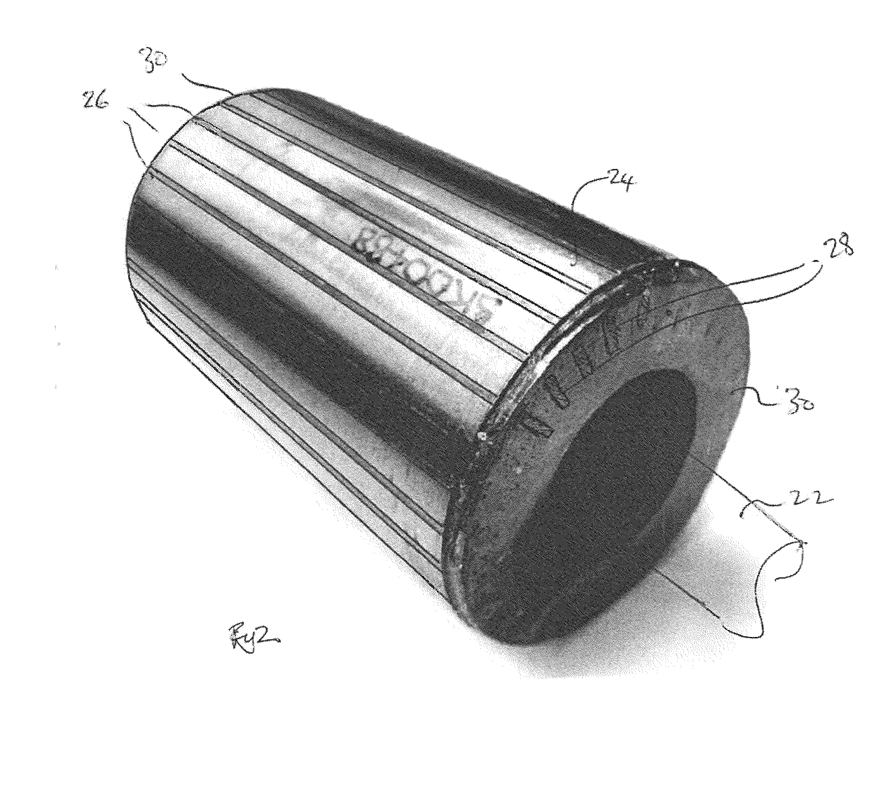

Referring now to FIG. 2, the rotor comprises a shaft 22, a core made up of longitudinally stacked laminations 24 of magnetic material (e.g., steel) defining passages for a plurality of rotor bars 26 which, in this embodiment, extend axially through the stack of laminations, at equally spaced angular increments. The ends of the bars project away from the stack and are received in respective apertures 28 in first and second end rings 30. In this embodiment, the cage comprising the rotor bars 26 and end rings is fabricated by assembling the separate elements, although in other arrangements at least part of the cage structure may be cast out of a suitable metal such as aluminum where a suitable thin insulating coating can be found that can withstand the casting temperatures of the cast material. Each of the rotor bars is made from a suitable electrically conducting material such as copper, phosphor-bronze etc, of the required cross section, which has received a surface treatment by plasma coating a ceramic insulating material onto the bar stock. The ceramic material may conveniently comprise zirconia or alumina ceramic and may be applied by plasma coating. The ceramic coating is required to provide effective electrical insulation to prevent current flowing from the bar, circumferentially into the laminations and thence into another bar. For this purpose, the ceramic coating may therefore typically be 125 μm thick, with the coating having a breakdown voltage of less than 10 Volts. Once cut, the rotor bars are then fitted into the lamination stack, leaving the free ends projecting from opposite ends of the stack. The end rings 30 with suitably disposed apertures are then fitted at each end and the rotor bars are electrically and structurally connected in the apertures of the end rings by e.g. TIG welding. The assembly then may be double impregnated using polyester varnish to fill the clearance between the bars and the slots to prevent vibration fatigue fractures of the bars and to prevent corrosion of the lamination steel, and thereafter machined to provide the required outside and inside diameter dimensions. The rotor may then be fitted to its shaft 22.

The rotor so formed is therefore designed to eliminate or at least reduce current flowing from the rotor bars to the laminations. This reduces the losses that would otherwise be associated with a rotor of this size and construction (but without the insulated rotor bars).

In another embodiment, the rotor bars may be made of extruded aluminum which is anodized to provide an insulating coating.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A rotor for a high slip variable frequency induction motor, the rotor comprising:
an elongated stacked lamination core having a length and diameter;
a plurality of electrically conducting rotor bars extending through the elongated stacked lamination core, each of the rotor bars having a first end and a second end;
an electrically conducting first end ring; and
an electrically conducting second end ring,
wherein the electrically conducting first and second end rings are connected to the first and second ends respectively of the rotor bars,
wherein an insulating material is disposed between the rotor bars and the elongated stacked lamination core so as to reduce or prevent parasitic current flow between the rotor bars and the elongated stacked lamination core.

2. The rotor of claim 1, wherein the insulating material is sufficient to keep the parasitic loss below 5%.

3. The rotor of claim 1, wherein the electrically conducting rotor bars include a surface treatment to provide a coating of insulating material.

4. The rotor of claim 3, wherein the treatment includes coating with a ceramic or ceramic-based insulating coating.

5. The rotor of claim 3, wherein the electrically conducting rotor bars include aluminum, and
wherein the treatment includes anodizing the electrically conducting rotor bars, so as to provide an insulating anodic coating.

6. The rotor of claim 5, wherein the insulating anodic coating has a breakdown voltage of less than 10 Volts.

7. A high slip variable frequency electric motor arrangement, comprising:
the rotor of claim 1; and
a voltage source configured to supply a variable frequency voltage to the rotor so as to control a speed of the rotor.

8. The motor of claim 7, wherein the voltage source is configured to supply a voltage of variable frequency of at least 700 Hz.

9. The motor of claim 7, wherein the voltage source is configured to supply a voltage of variable frequency within a range of at least 360 Hz to 800 Hz.

10. The motor of claim 7, having a power output in a range of from 0.5 to 10 kW.

11. A method of reducing parasitic current flow in a high slip variable frequency induction motor having a rotor including an elongate stacked laminated core, a plurality of electrically conducting rotor bars extending through the elongated stacked laminated core and each of the rotor bars having a first and a second end with the first and second ends being electrically connected by respective first and second end rings, the method comprising:
providing an insulating material between the rotor bars and the core so as to prevent or reduce current flow between the bars and the core.

12. A method of forming a rotor for a high slip variable frequency induction motor, the method comprising:
providing an elongated stacked lamination core, the elongated stacked lamination core including a plurality of electrically conducting rotor bars extending through the elongated stacked lamination core, each of the electrically conducting rotor bars having a first and a second end, with the first and the second ends being electrically connected by respective first and second end rings, and
providing an insulating material between the rotor bars and the core so as to prevent or reduce current flow between the rotor bars and the elongated stacked lamination core in operation.

13. The method of claim 11, wherein the providing the insulating material includes surface treating the electrically conducting rotor bars with the insulating material.

14. The method of claim 12, wherein the providing the insulating material includes applying an insulating coating.

15. The method of claim 14, wherein the insulating coating is a ceramic-including coating.

16. The method of claim 13, wherein the electrically conducting rotor bars include aluminum, and
wherein the surface treating includes anodizing the electrically conducting rotor bars to provide an anodic coating or layer.

17. The method of claim 11, further comprising:
applying a surface treatment to one or more surfaces of the elongated stacked lamination core adjacent the electrically conducting rotor bars.

18. A fuel pump arrangement, comprising:
a pump; and
an electric motor configured to be located in a fuel tank and immersed in fuel in use,
wherein the electric motor includes the rotor of claim 1.

19. The rotor of claim 1, wherein the insulating material is sufficient to keep the parasitic loss below 1%.
